(19) United States
(12) Patent Application Publication
(10) Pub. No.: US 2015/0052225 A1
(43) Pub. Date: Feb. 19, 2015

(54) SYSTEM AND METHOD FOR CONTENT DOWNLOAD

(71) Applicant: THOMSON LICENSING, Issy de Moulineaux (FR)

(72) Inventor: Brian Duane Clevenger, Muncie, IN (US)

(21) Appl. No.: 14/390,130

(22) PCT Filed: May 1, 2013
(86) PCT No.: PCT/US13/38977

§ 371 Date: Oct. 2, 2014

Related U.S. Application Data
(60) Provisional application No. 61/640,905, filed on May 1, 2012.

(51) Int. Cl. H04L 29/06; G11B 27/10; G11B 20/10; H04L 29/08

(52) U.S. Cl. CPC H04L 65/4092; H04L 67/10; G11B 27/10; G11B 20/10527; G11B 2020/10537
USPC 709/219

(57) ABSTRACT

A method and apparatus for downloading a content file wherein content data is downloaded out of sequence, with data required to begin playback being downloaded first are described. The method and apparatus for downloading a content file include allocating a storage space for the content file, downloading a first portion of data located at the beginning of the content file to the storage space, processing the first portion of data for determining a file type of the content file, downloading a second portion of data from the content file to the storage space wherein, a location of the second portion within the content file is determined responsive to the file type, and the second portion may be out of sequence with the first portion.

### CROSS REFERENCE TO RELATED APPLICATIONS

This application claims the benefit of U.S. Provisional Application Ser. No. 61/640,905 filed May 1, 2012, which is incorporated by reference herein in their entirety.

### FIELD OF THE INVENTION

The invention relates to progressive content downloading, and, in particular, to a download manager and pipeline construction, where content is downloaded out of sequence.

### BACKGROUND OF THE INVENTION

Various problems relating to content download and content playback are addressed by the described system and method. For example, a user may wish to download content, e.g., a video file, and start playing it back before the download completes. Certain data formats such as Moving Pictures Experts Group (MPEG) transport streams are designed for streaming and such formats may facilitate solving the described problem. However, other data “container” formats such as Audio Video Interleave (AVI) may necessitate reading metadata and/or indexing information located at the end of the file before playback can begin (otherwise features such as seeking and trick modes will not be possible during playback). The described system and method solve this problem for all container types. A second problem involves a user who would like to seek to a position in the video that has not yet been downloaded. The described system and method enable the file to be downloaded out of sequence such that the user can immediately begin viewing content at the requested position.

Video-on-demand, peer-to-peer (P2P) services and streaming video services have partial solutions to the above identified problems but do not completely solve the problems raised above.

### SUMMARY OF THE INVENTION

A system and method as described herein provide for downloading content to a media player so that playback can occur while a download is in progress even if the downloaded content was not designed for streaming. In addition, the content (file, file content) download may be controlled based on what the user wants to play. For example, if the user wants to start playback in the middle of the content file, the content the user wants to view will be downloaded first.

As used herein the terms “file”, “content”, “content file” and “file content” are used interchangeably. Also as used herein metadata may include indexing information, chapter offsets or any other information that may be used to aid in the decoding of the content (file, data). The metadata, indexing information, chapter offsets etc may reside at the end of the file (content, data) or at some offset within the file. The metadata, indexing information, chapter offsets etc may be contiguous or may be broken up into multiple segments (chunks, blocks, units) located at different offsets in the file (content, data).

A method and apparatus for downloading a content file wherein content data is downloaded out of sequence, with data required to begin playback being downloaded first are described. The method and apparatus for downloading a content file include allocating a storage space for the content file, downloading a first portion of data located at the beginning of the content file to the storage space, processing the first portion of data for determining a file type of the content file, downloading a second portion of data from the content file to the storage space wherein, a location of the second portion within the content file is determined responsive to the file type, and the second portion may be out of sequence with the first portion.

### BRIEF DESCRIPTION OF THE DRAWINGS

The present invention is best understood from the following detailed description when read in conjunction with the accompanying drawings. The drawings include the following figures briefly described below:

FIG. 1 is a block diagram of a media pipeline used to render a fully downloaded content file.

FIG. 2 is a block diagram of an exemplary pipeline controlling a download manager in accordance with the principles of the present invention.

FIG. 3 is a block diagram of an exemplary pipeline controlling a download manager while rendering content in accordance with the principles of the present invention.

FIG. 4 is a flowchart of an exemplary implementation of a download manager in accordance with the principles of the present invention.

FIG. 5 shows a possible downloading sequence for a media file in accordance with the principles of the present invention.

### DETAILED DESCRIPTION OF THE INVENTION

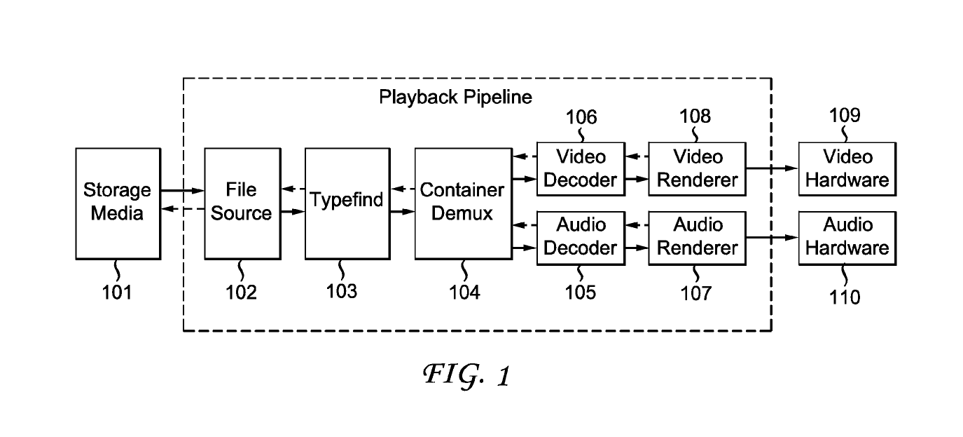

FIG. 1 shows an exemplary pipeline for playing back (rendering) media content. In this figure solid arrows depict the flow of media content and dotted arrows depict control paths. When the video renderer or audio renderer is ready for more data to send to the hardware, the video and audio renderers ask the upstream video and audio decoder elements for the next decoded frame. The decoder elements in turn ask the container demux for the next encoded frame. The container demux sends an upstream request to the typefind element for the byte offsets into the media file of the next encoded frames. The typefind element passes through this request to the source element. Finally, the source element retrieves the requested data from the file located on the storage media. The File Source (102) retrieves data from the Storage Media (101). A Typefind element (103) requests data from the File Source (102) as needed to determine the type of file being played (rendered). This data (information) is used to construct the appropriate Container Demux (104). After the file type is determined, the Typefind element (103) no longer directly requests data from the File Source (102) and instead acts a transparent pass-through element, allowing the Container Demux (104) to read data from the File Source (102). The Container Demux (103) reads and processes all information necessary for playback (rendering) and presentation to the user including any metadata and indexing information. It then constructs the necessary decoder elements (105) and (106) for decoding any contained audio and video streams. The decoder elements (105) and (106) request encoded frames from the Container Demux (103) and decode the frames. The renderer elements (107) and (108) request decoded frames from the decoder elements (105) and (106) and synchronize the timing for final output to hardware devices (109) and (110).

The architecture described in FIG. 1 can be used to play media content that has been fully downloaded or partially downloaded content that was designed to be streamed such as a MPEG Transport Stream. However, for content that was not designed to be streamed such as AVI, the pipeline described in FIG. 1 may fail to play the partially downloaded content or may play the content with reduced functionality such as no support for seek or trick mode operations.

An aspect of the system and method of the present invention that solves the limitations of the pipeline described in FIG. 1 includes a download manager (DLM) having an interface that allows data to be downloaded out of sequence. The DLM allocates the space for the entire file on disk. The DLM then provides an API that allows a component to, for example, command (request) “download X bytes at offset Y and notify me when done”. If the DLM already downloaded those bytes, the DLM would send the notification immediately. Otherwise, the DLM would download the bytes requested, send the notification, and then return to filling in other gaps in the file content.

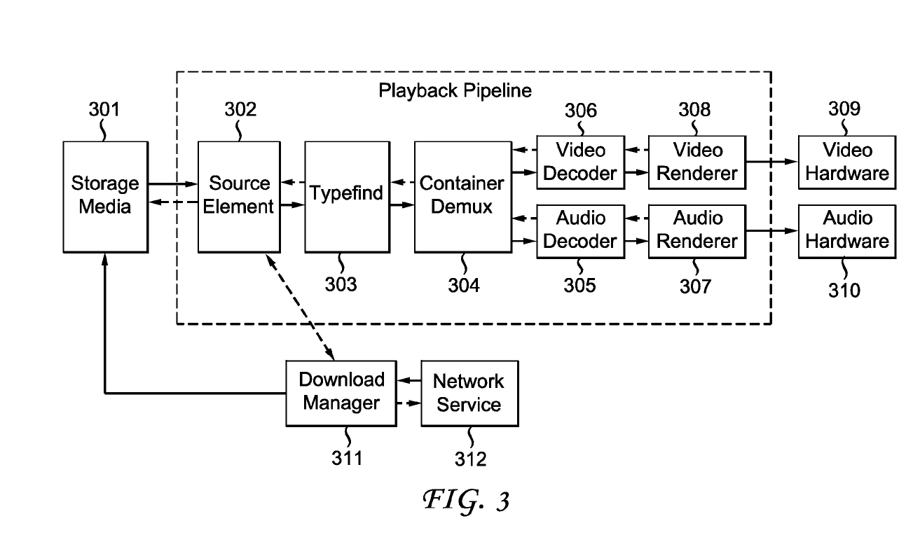

With this API, an interface is created that allows a media pipeline to interact with the DLM to control which parts of the file are downloaded based on the pipeline's needs for playback. This embodiment is shown in FIG. 3. In FIG. 3, solid arrows depict the flow of media content and dotted arrows depict control paths. When the Typefind element (303) or Container Demux (304) makes a request to the Source Element (302), the Source Element (302) sends a request to the Download Manager (311) with the range of data it needs to read from the Storage Media (301). The Download Manager (311) then stops its download progress and immediately downloads the range of data requested by the Source Element (302) from the Network Service (312) if the requested data has not already been downloaded and writes it to the Storage Media (301). After the Download Manager (311) ensures that the requested data has been written to the Storage Media (301), the Download Manager (311) sends a notification to the Source Element (302) to indicate that the requested data is present in the Storage Media (301). After receiving the notification, the Source Element (302) reads the requested data from the Storage Media (301) and sends the data to downstream elements in the pipeline. The function of the Typefind element (303), Container Demux (304), Audio Decoder (305), Video Decoder (306), Audio Renderer (307), Video Renderer (308), Video Hardware (309), and Audio Hardware (310) are identical to the function of these same elements described in FIG. 1.

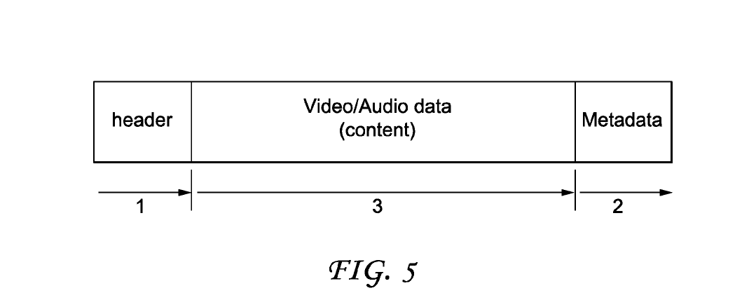

Another aspect of the present invention includes providing for downloading a certain percentage of the file and then commencing playback (rendering). For example, consider the AVI container format. Before beginning playback it may be desirable to have available a large portion of data at the beginning of the file. But, there may also be a need for a small portion of data at the end of the file to retrieve the metadata which may include indexing information, chapter offsets or any other information that may aid in decoding the content. FIG. 5 shows an exemplary media file including some initial header information, a section of audio and video content, and some metadata necessary for playback located at the end of the file. Instead of downloading this content sequentially, it is advantageous to download the header information, the metadata, and then download the audio and video content. This sequence for downloading the content is shown by arrows labeled 1, 2, and 3. By downloading the content in this sequence, it ensures that if playback of partially downloaded content is later requested, all of the data required to begin playback will already be downloaded. This allows content playback to begin immediately instead of requiring a delay while other necessary portions of the content are downloaded.

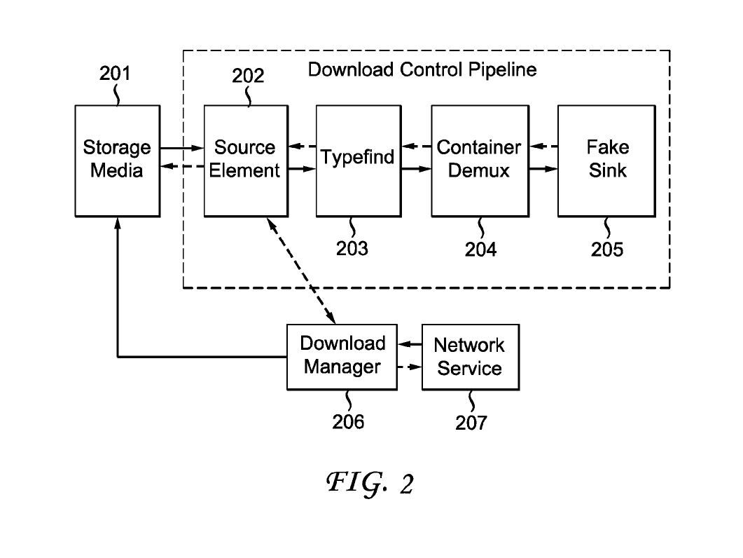

FIG. 2 shows an exemplary pipeline used to control a Download Manager to ensure content is downloaded in the sequence described by FIG. 5. In FIG. 2, solid arrows depict the flow of media content, and dotted arrows depict control paths. In FIG. 2, the Storage Media (201), Source Element (202), Typefind element (203), Container Demux (204), Download manager (206), and Network Service (207) all function the same as described in FIG. 3. However, the decoder, renderer, and hardware blocks are replaced by a Fake Sink element (205). The Fake Sink (205) reads and discards data from the Container Demux (204). Since there are no renderer elements to control the rate of playback and presentation to the user, the download can proceed as fast as the Network Service (207) permits. Additionally, since there are no elements decoding the audio and video data, the processing and memory resources required to construct the pipeline described in FIG. 2 are minimal This makes it practical to construct the pipeline described in FIG. 2 for the purposes of controlling the sequence of a download before playback of the content is requested. If playback is later requested before the download completes, the pipeline described in FIG. 2 can be replaced by the pipeline described in FIG. 3 to allow playback of the conent.

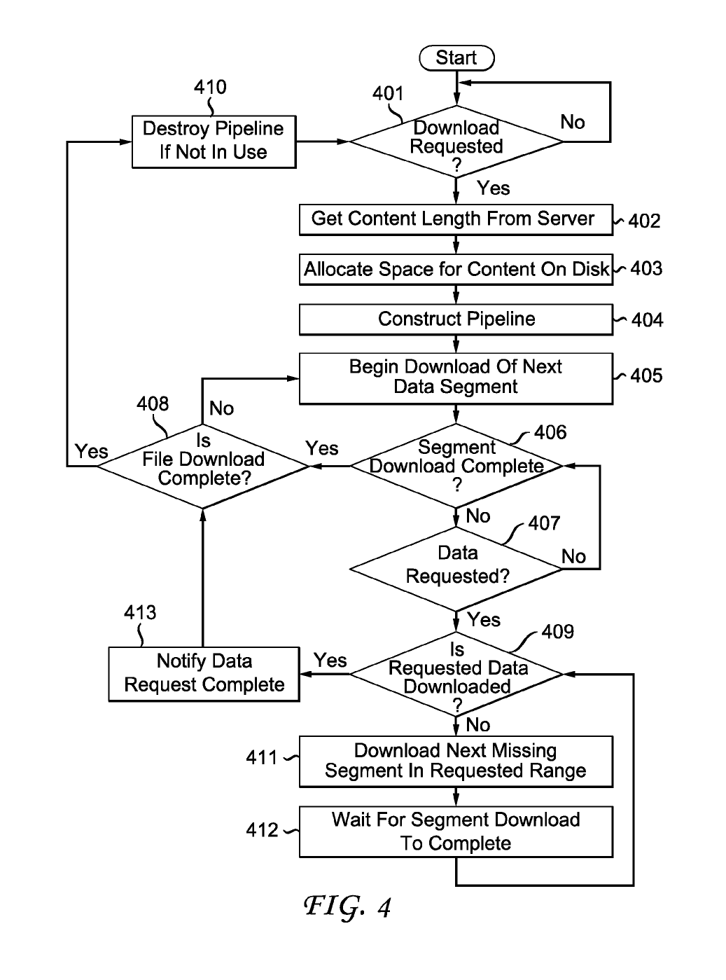

An aspect of the present invention is a Download Manager (DLM) that allows the sequence it downloads the data to be controlled by a pipeline processing the downloaded data. FIG. 4 describes the operation of the DLM in the present invention. The DLM waits at step 401 until a download request is received. It then queries the server for the content length (402). Once the content length has been retrieved, it allocates space for the entire file on disk (403). This step is important because it allows the DLM to download the file out of sequence and write to the appropriate offsets in the file as the data is downloaded. This eliminates the need to reconstruct downloaded segments into a contiguous file when the download completes and eliminates any special processing by the pipeline's source element while the download is in progress.

After space for the entire file is allocated on disk, the pipeline is constructed (404). If immediate playback of the content is desired, the pipeline described in FIG. 3 is constructed to facilitate playback. Otherwise, the pipeline described in FIG. 2 is constructed. Once the pipeline is constructed, the download manager begins downloading the next segment. In FIG. 4, a segment is a block of contiguous data in a content file. The next segment at step 405 will always be the first block of contiguous data in the content file that has not been previously downloaded.

After the download in step 405 begins, the DLM then waits until either the segement download completes (406) or until a data request is received from the pipeline (407). If the segment download completes (406), processing moves to step 408 to check if the download has completed. A download is completed when no more segments remain to be downloaded. If the download is complete, processing moves to step 410 where the pipeline is destroyed if it is not currently being used to playback the content. Finally, processing returns to step 401 where the DLM waits for the next download request. If at step 408 the download is not complete, processing returns to step 405 to begin download of the next segment.

When a data request is received from the pipeline (407), the DLM checks if the requested data has already been downloaded (409). If the requested data has already been downloaded, the DLM notifies the pipeline that the request is complete (413). Processing then moves to step 408. If at step 409, it is determined that not all of the requested data has been previously downloaded, processing moves to step 411. At step 411, and download in progress is halted and downloading begins at the first missing segment in the requested range. Processing then moves to step 412 where the DLM waits until the download started at step 411 completes. Processing then returns to step 409 to determine if any other segments must be downloaded.

As described in FIG. 4, the DLM requires support for starting a download at a specified offset (based on protocol and server capabilities), e.g., for resuming downloads. This functionality is defined by many standard protocols such as the Hypertext Transfer Protocol (HTTP) and the File Transfer Protocol (FTP). The DLM will need to track which portions of the file have been downloaded in a database so that downloads can be resumed after a power cycle. However, the DLM may also maintain a database for downloads (e.g., structured query language (SQL)), thereby facilitating adding an additional table to track the sections of the file (content) that have been downloaded.

As mentioned above, the described system and method of the present invention may include another aspect involving “smart” pre-buffering. For example, there may be cases where the user chooses to download a file (content), and then start playback at some later time. In these cases, it may be desirable to begin intelligently downloading the parts of the file that will be needed for playback even before playback begins. In this case, the download would begin using the pipeline described in FIG. 2. This pipeline allows the content to be downloaded in an order that will optimize playback experience if playback is started at a later time before the download completes. When playback is requested, the pipeline described in FIG. 2 is replaced by the pipeline described in FIG. 3 allowing playback of the content. While the pipelines described in FIGS. 2 and 3 may be software-only, they may also be implemented in software, hardware, firmware or any combination thereof including application specific integrated circuits (ASICs), reduced instruction set computers (RISCs) and/or field programmable gate arrays (FPGAs).

It is to be understood that the present invention may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed Given the teachings herein, one of ordinary skill in the related art will be able to contemplate these and similar implementations or configurations of the present invention.

1. A method for downloading a content file wherein content data is downloaded out of sequence, with data required to begin playback being downloaded first, said method comprising:
allocating a storage space for said content file;
downloading a first portion of data located at the beginning of the content file to the storage space;
processing the first portion of data for determining a file type of the content file; and
downloading a second portion of data from the content file to the storage space wherein, a location of the second portion within the content file is determined responsive to the file type, and the second portion may be out of sequence with the first portion, wherein said second portion of data comprises one of metadata, indexing information, chapter offsets and any other useful decoding information.

2. (canceled)

3. The method according to claim 1, wherein the second portion of data is located at one of an end of the content file and within the content file.

4. The method according to claim 2, wherein said second portion is a plurality of units of information located at various places throughout the content file.

5. The method according to claim 1, wherein said second portion of data comprises one of metadata, indexing information, chapter offsets and any other useful decoding information.

6. The method of claim 2, further comprising the steps of:
selecting a third portion of data in the content file responsive to the second portion of data wherein the third portion of data is out of sequence with the first and second portions of data, and
downloading the third portion of data to the storage space.

7. The method of claim 6, wherein the step of selecting said third portion of data in the content file is responsive to the second portion of data and to a user request for content at a particular location of the content file.

8. The method of claim 7, further wherein the user request comprises one of start playback at a later time and seek to a position of the content file.

9. An apparatus for downloading a content file wherein content data is downloaded out of sequence, with data required to begin playback being downloaded first, comprising:
a data storage device;
a first processor bi-directionally coupled to the data storage device for managing download of a content file from a source to the data storage device;
a second processor for extracting a first portion of data from the content file, wherein the first processor allocates space in the data storage device for storing the content file responsive to said first portion of data, said second processor bi-directionally coupled to said first processor; and
said second processor also downloading a second portion of data from said content file, a location of the second portion of data within the content file is determined responsive to the control information, and the second portion of data may be out of sequence with the control information.

10. (canceled)

11. The apparatus according to claim 9, wherein said second portion of data is located at an end of said content file or within said content file.

12. The apparatus according to claim 10, wherein said second portion of data is a plurality of units of information located at various places throughout the content file.

13. The apparatus according to claim 9, wherein said second portion of data comprises one of metadata, indexing information, chapter offsets and any other useful decoding information.

14. The apparatus according to claim 10, wherein said second processor selects a third portion of data in the content file responsive to the second portion of data, wherein the third portion of data is out of sequence with the first and second portions of data, and wherein said second processor downloads the third portion of data to the data storage device.

15. The apparatus according to claim 14, wherein the selecting of said third portion of data in the content file by the second processor is responsive to the second portion of data and to a user request for content at a particular location of the content file.

16. The apparatus according to claim 15, further wherein the user request comprises one of start playback at a later time and seek to a position of the content file.

17. The apparatus according to claim 15, further comprising a third processor bi-directionally coupled to said data storage device, said first processor and said second processor, and further wherein said third processor receives said user request.

18. The apparatus according to claim 17, wherein said third processor controls playback of said third portion of data by interaction with the second processor.
